(19) United States
(12) Patent Application Publication
(10) Pub. No.: US 2026/0109485 A1
(43) Pub. Date: Apr. 23, 2026

(54) Positioning computer for a satellite having an optical inter-satellite communication system on an anti-Earth face

(71) Applicant: THALES, Meudon (FR)

(72) Inventor: Raphaël HACHE, CANNES LA BOCCA (FR)

(21) Appl. No.: 19/364,484

(22) Filed: Oct. 21, 2025

(30) Foreign Application Priority Data
Oct. 23, 2024 (FR) FR2411537

(51) Int. Cl. B64G 1/36

(52) U.S. Cl. CPC B64G 1/363; B64G 1/365

(57) ABSTRACT

A positioning computer for a satellite intended to move in an orbital plane, the satellite being intended to include: a body having an Earth face defining an axis Z of the satellite intended to point towards the Earth, at least one optical system for communicating with another satellite located in the orbital plane, the first optical system being intended to be located on an anti-Earth face and have a field of view in azimuth around the axis Z, the field of view being limited by an obturation angle due to the body. The computer is adapted to obtain a parameter representing a solar angle defined by the Sun with the orbital plane, and to perform the calculation of a parameter representing the yaw angle of the satellite using at least the parameter representing the solar angle and a parameter representing the obturation angle.

### CROSS-REFERENCE TO RELATED APPLICATIONS

This application claims the benefit of French Application No. 24 11537, filed on Oct. 23, 2024, which is incorporated herein by reference in its entirety.

### BACKGROUND OF THE DISCLOSURE

### Field of the Disclosure

The present invention relates to a positioning computer for a satellite, specifically for telecommunications, adapted to provide a parameter representing a yaw angle of the satellite, the satellite being intended to move in an orbital plane and to communicate with at least one other satellite located in the orbital plane using an optical system, the computer being adapted to obtain a parameter representing a solar angle defined by the Sun with the orbital plane, and to perform a calculation of the parameter representing the yaw angle using at least the parameter representing the solar angle.

The invention also relates to a satellite comprising such a computer.

The invention also relates to a method for providing the parameter representing the yaw angle, a corresponding computer program product, as well as a method for positioning such a satellite.

### Description of Related Art

Operating satellite constellations making optical inter-satellite links is already known. The inter-satellite links allow a satellite to connect directly to its neighbors without descending to a third country. These links offer the possibility of connecting a user anywhere on Earth to a ground station, also anywhere on Earth, through successive hops within a global constellation framework.

In a constellation, at least some of the satellites evolve in the same orbital plane (they are said to be “intra-plane”), with relatively constant angular gaps between them, and communicate with each other step-by-step using optical systems allowing them to emit and/or receive signals.

Each satellite has a so-called “Earth” face that defines an axis Z pointing towards the Earth and which include antennas towards users, antennas towards ground stations, and possibly other equipment aimed at the Earth.

Furthermore, for its energy supply, each satellite comprise one or more solar panels mounted rotatably relative to the satellite's body around an axis Y, perpendicular to the axis Z. An axis X is also defined perpendicular to the other two. The axis X defines, with a reference axis X0 in the orbital plane, a yaw angle of the satellite around the axis Z.

The orientation of each satellite is usually controlled in such a way that the solar panels can be placed perpendicularly to the solar radiation by rotating around the axis Y. To do this, a computer determines a value of the yaw angle such that the Sun is in the plane defined by the axis X and the axis Z.

Each satellite is thus subject to a control law, called “yaw steering law,” which ensures that the solar panels are correctly oriented according to the angle made by the Sun relative to the orbital plane, and the position of the satellite on its orbit.

Each satellite includes up to three or four optical systems ensuring inter-satellite links, for example. Each optical system targets another satellite in a direction forming a 60° angle with the axis Z in the orbital plane, for example. To have the other satellite in its field of view under all circumstances, knowing that the yaw angle potentially varies from 0° to 180°, each of the optical systems is located on the Earth face.

The presence of optical systems on the Earth face, in addition to the aforementioned equipment, creates a certain clutter on the Earth face, which must be taken into account when designing satellites.

An aim of the invention is to remedy all or part of the above disadvantages by providing equipment that alleviates the constraint due to the clutter of the Earth face while preserving the operation of the satellite, specifically the inter-satellite links.

### SUMMARY OF THE DISCLOSURE

The invention aims at a positioning computer for a satellite adapted to provide a parameter representing a yaw angle of the satellite, the satellite being intended to move in an orbital plane, the satellite and a sub-solar point of the orbital plane being intended to define a satellite position angle as seen from Earth, the satellite being intended to comprise:
a body having an Earth face defining an axis Z of the satellite, intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining the yaw angle, the reference axis X0 being perpendicular to the axis Z, located in the orbital plane and oriented in the direction of an increase in the position angle, and
at least one first optical system for communicating with another satellite located in the orbital plane, the first optical system being intended to be located on an anti-Earth face of the satellite, opposite the Earth face according to the axis Z, and intended to have a field of view in azimuth around the axis Z, the field of view comprising a first direction parallel to the axis Y and extending to a second direction forming, with the first direction, an angle of 180° minus an obturation angle due to the body,
the computer being adapted to obtain a parameter representing a solar angle defined by the Sun with the orbital plane, and to perform a calculation of the parameter representing the yaw angle using at least the parameter representing the solar angle,
wherein the computer is configured to use a parameter representing the obturation angle in said calculation.

According to other advantageous aspects of the invention, the computer comprises one or more of the following features, taken alone or in all technically possible combinations:
it is configured to calculate the parameter representing the yaw angle differently depending on whether the parameter representing the solar angle belongs to value ranges;
it is configured so that: if the parameter representing the solar angle is such that the solar angle is less than or equal in absolute value to a first threshold, the parameter representing the yaw angle is equal to a constant; if the parameter representing the solar angle is such that the solar angle is greater in absolute value than a second threshold greater than the first threshold, then the parameter representing the yaw angle is calculated according to a yaw steering law such that the Sun is intended to be in a plane defined by the axis X and the axis Z; and if the parameter representing the solar angle is such that the solar angle is less than or equal in absolute value to the second threshold and greater than the first threshold, then the parameter representing the yaw angle is calculated according to said yaw steering law limited to a maximum value; and
the first threshold is equal to the obturation angle divided by two; the second threshold is equal to the obturation angle; said maximum value is equal to 180° minus the obturation angle; and/or said constant is equal to zero.

The invention also aims at a satellite intended to move in an orbital plane, the satellite and a sub-solar point of the orbital plane defining a satellite position angle as seen from Earth, the satellite comprising:
a body having an Earth face defining an axis Z of the satellite intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining a yaw angle of the satellite around the axis Z, the reference axis X0 being perpendicular to the axis Z, located in the orbital plane and oriented in the direction of an increase in the position angle,
at least one first optical system for communicating with another satellite located in the orbital plane, the first optical system being located on an anti-Earth face of the satellite, opposite the Earth face according to the axis Z, and having a field of view in azimuth around the axis Z, the field of view comprising a first direction parallel to the axis Y and extending to a second direction forming with the first direction an angle of 180° minus an obturation angle due to the body, and
a computer as described above, adapted to provide a parameter representing the yaw angle, the computer being adapted to obtain a parameter representing a solar angle defined by the Sun with the orbital plane, and to perform a calculation of the parameter representing the yaw angle using at least the parameter representing the solar angle,
wherein the computer is configured to use a parameter representing the obturation angle in said calculation.

According to other advantageous aspects of the invention, the satellite comprises one or more of the following features, taken alone or in all technically possible combinations:
the anti-Earth face defines four corners, with the first optical system being fixed on one of the four corners and protruding relative to the anti-Earth face according to the axis Z towards space; and
the satellite comprises a second optical system fixed on another of the four corners and protruding relative to the anti-Earth face according to the axis Z towards space, the other of the four corners being diagonally opposite the one of the four corners on which the first optical system is fixed.

The invention also aims at a method for providing a parameter representing a yaw angle of a satellite, the satellite being intended to move in an orbital plane, the satellite and a sub-solar point of the orbital plane being intended to define a satellite position angle as seen from Earth, the satellite being intended to comprise:
a body having an Earth face defining an axis Z of the satellite intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining the yaw angle, the reference axis X0 being perpendicular to the axis Z, located in the orbital plane and oriented in the direction of an increase in the position angle, and
at least one first optical system for communicating with another satellite located in the orbital plane, the first optical system being intended to be located on an anti-Earth face of the satellite, opposite the Earth face according to the axis Z, and intended to have a field of view in azimuth around the axis Z, the field of view comprising a first direction parallel to the axis Y and extending to a second direction forming, with the first direction, an angle of 180° minus an obturation angle due to the body,
the method comprising:
a computer as described above obtaining a parameter representing a solar angle defined by the Sun with the orbital plane, and
a calculation by the computer of a parameter representing the yaw angle using at least the parameter representing the solar angle,
wherein the method comprises the computer using a parameter representing the obturation angle in said calculation.

The invention also aims at a computer program product including software instructions which, when implemented by computer equipment, allow the method as defined above to be carried out.

The invention also aims at a method for positioning a satellite as described above, the satellite moving in an orbital plane, the satellite and a sub-solar point of the orbital plane defining a satellite position angle as seen from Earth, the method comprising:
a computer obtaining a parameter representing the solar angle, and
a calculation by the computer of a parameter representing the yaw angle using at least the parameter representing the solar angle,
wherein the method comprises the computer using a parameter representing the obturation angle in said calculation.

### BRIEF DESCRIPTION OF THE SEVERAL VIEWS OF THE DRAWINGS

The invention will appear more clearly upon reading the following description, given solely by way of non-limiting example, and made with reference to the appended drawings, wherein:

FIG. 1 is a schematic view of a satellite according to the invention, in orbit around the Earth, the satellite being represented in four successive positions on its orbit, corresponding to four position angles of approximately 0°, 90°, 180° and 270°,

FIG. 2 is a schematic view of a satellite constellation including the satellite represented in FIG. 1, the constellation being located in the orbital plane of the satellite and viewed in a direction perpendicular to the orbital plane.

FIG. 3 is a schematic perspective view of the satellite represented in FIGS. 1 and 2, showing two optical communication systems, the Earth face of the satellite being directed upwards, and

FIG. 4 is a schematic view of the satellite represented in FIGS. 1 to 3, according to the axis Z, showing the anti-Earth face, the two optical systems represented in FIG. 3, and their respective fields of view.

### DETAILED DESCRIPTION

### Satellite

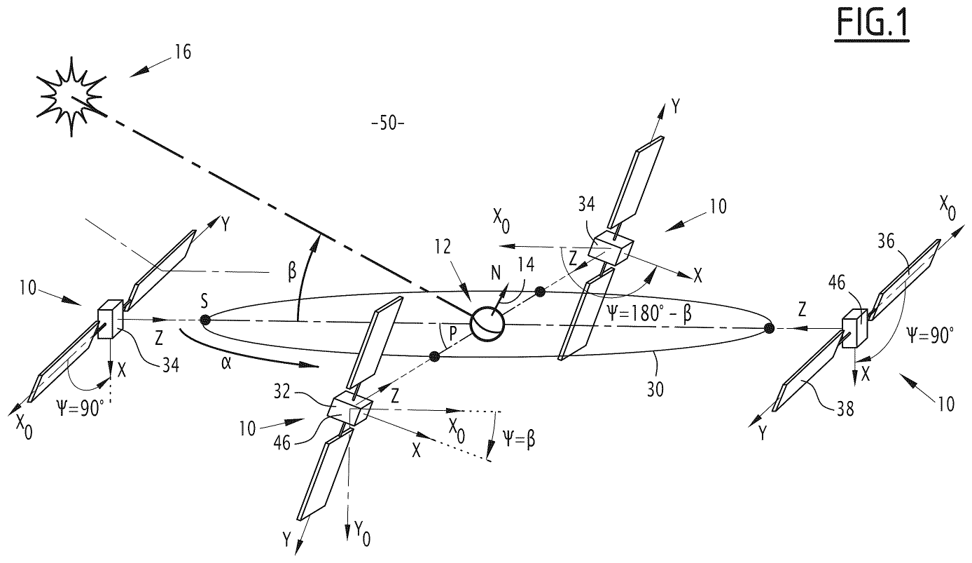

Referring to FIG. 1, an artificial satellite 10 according to the invention is described. The satellite 10 is in orbit around the Earth 12, whose own rotation axis 14 is represented, in an orbital plane P with which the sun 16 defines a solar angle β.

The satellite 10 defines with a sub-solar point S a position angle α in the orbital plane P, seen from the Earth 12. In FIG. 1, the satellite 10 is represented in four successive positions corresponding approximately to the values 0°, 90°, 180° and 270° of the position angle α.

The sub-solar point S indicates the direction of the Sun 16 relative to the Earth 12 in the orbital plane P.

The satellite 10 is a telecommunications satellite, for example, having already known specific equipment for this function, which will not be detailed.

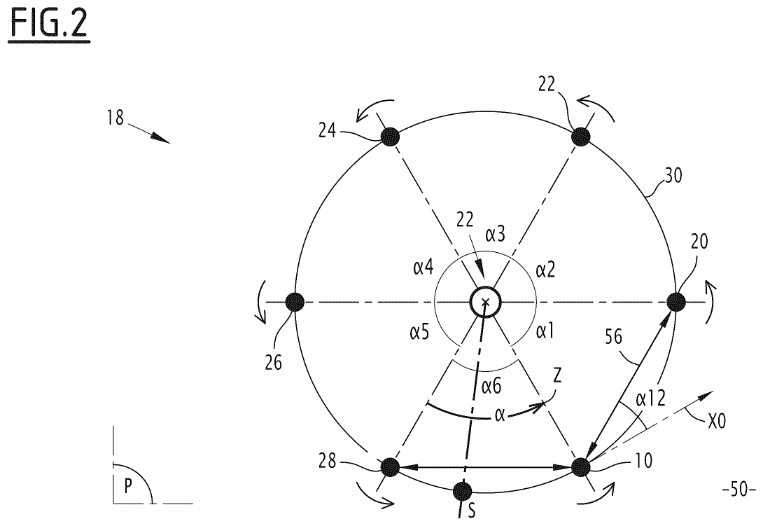

The satellite 10 advantageously forms part of a constellation 18, represented in FIG. 2, including, for example, five other satellites 20, 22, 24, 26 and 28 analogous to the satellite 10 and moving in the orbital plane P, advantageously on the same orbit 30 as the satellite 10. The other satellites 10, 20, 22, 24, 26 and 28 define successive angles α1, α2, α3, α4, α5 and α6, for example, approximately equal as seen from the Earth 12, at approximately 60° in the example.

In a variant (not represented), the constellation 18 includes a different number of satellites, such as seven or eight, and/or the satellite 10, the other satellites 20, 22, 24, 26 and 28 do not define approximately equal angles between them.

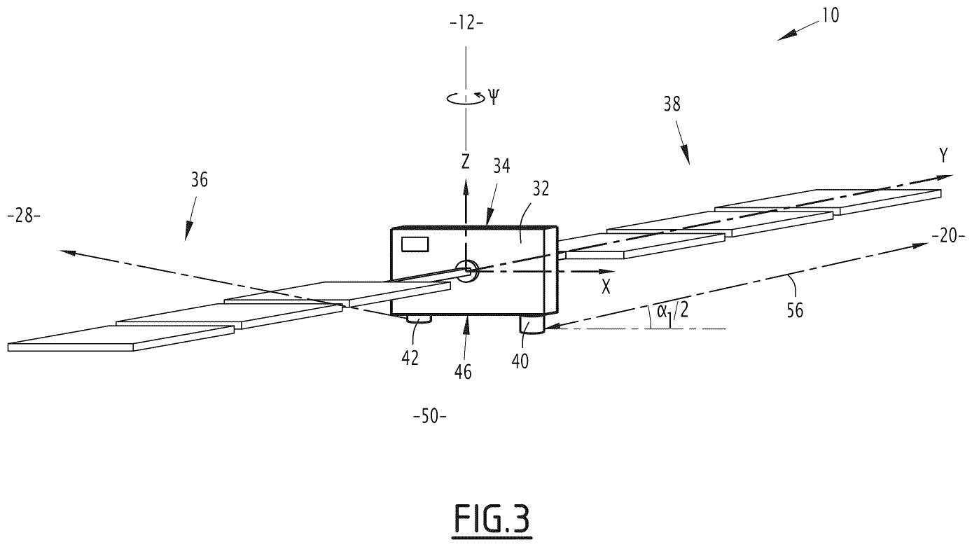

The satellite 10 comprises a body 32 (FIGS. 1, 3) having an Earth face 34 defining an axis Z linked to the satellite and pointing towards the Earth 12.

The satellite 10 comprises two solar panels 36, 38 mounted rotatably relative to the body 32 around an axis Y of the satellite perpendicular to the axis Z.

In a variant (not represented), the satellite 10 comprises only one solar panel.

The satellite 10 also defines an axis X perpendicular to the axis Y and the axis Z.

The axis X and a reference axis X0 together define a yaw angle ψ of the satellite around the axis Z, the reference axis X0 being perpendicular to the axis Z, located in the orbital plane P and oriented in the direction of an increase in the position angle α.

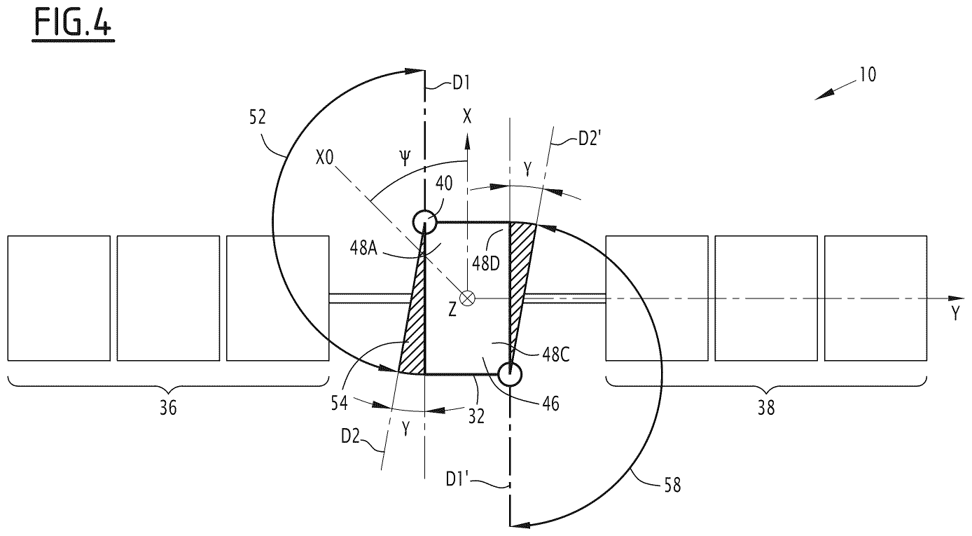

The satellite 10 comprises a first optical system 40 (FIGS. 3 and 4) for communicating with another satellite of the constellation 18, such as the satellite 20 preceding the satellite 10, and, advantageously, a second optical system 42 for communicating with another satellite, such as the satellite 28 following the satellite 10 in the constellation 18.

The satellite 10 comprises a computer 44 (FIG. 3) adapted to provide a parameter representing the yaw angle ψ, such as the yaw angle ψ itself.

By “a parameter representing a quantity,” it is meant that the quantity can be obtained from this parameter.

As visible in FIGS. 3 and 4, the first optical system 40 and the second optical system 42 are located on an anti-Earth face 46 of the satellite, opposite the Earth face 34 according to the axis Z.

The anti-Earth face 46 defines four corners 48A, 48B, 48C and 48D, for example, the first optical system 40 being advantageously fixed on one of the four corners 48A, 48B, 48C or 48D and protruding relative to the anti-Earth face 46 according to the axis Z towards space 50 (opposite the Earth according to the axis Z).

A “corner” means an area of the anti-Earth face 46, for example, located less than 30 cm, or even less than 20 cm, from a vertex.

The first optical system 40 has a field of view 52 in azimuth around the axis Z, the field of view 52 comprising a first direction D1 parallel to the axis Y and extending without interruption to a second direction D2 forming, with the first direction D1, an angle of 180° minus an obturation angle γ due to the body 32. Indeed, although the first optical system 40 is protruding relative to the anti-Earth face 46, this face prevents it from communicating with the satellite 20 when the satellite 20 is in azimuth in the shaded angle 54 in FIG. 4, the body 32 then constituting an obstacle for the optical signals 56.

Similarly, in the example, the second optical system 42 is advantageously fixed on another of the four corners 48A, 48B, 48C or 48D and is protruding relative to the anti-Earth face 46 according to the axis Z towards space 50, the other of the four corners being diagonally opposite to the one of the four corners on which the first optical system 40 is fixed.

The second optical system 42 has a field of view 58 in azimuth around the axis Z, the field of view 58 comprising a first direction D1′ parallel to the axis Y (and therefore to the direction D1) and extending without interruption to a second direction D2′ forming, with the first direction D1′, an angle of 180° minus the obturation angle γ.

The obturation angle γ specifically depends on the shape of the body 32, the elevation angle between the optical system 42 and the satellite 28, and the arrangement of the optical system 42 on the body 32.

Advantageously, the first optical system 40 and the second optical system 42 are located in cantilever relative to the anti-Earth face 46, specifically according to the axis Y. In other words, the first optical system 40 and the second optical system 42 “protrude” from the anti-Earth face 46 according to the axis Y. This cantilever is schematically visible in FIG. 4.

The obturation angle γ is advantageously as small as possible, and is between 10° and 20°, for example.

### Computer and Obtaining the Yaw Angle

The computer 44 is adapted to obtain a parameter representing the solar angle β, such as the solar angle β itself, and advantageously at least one parameter representing the obturation angle γ, such as the obturation angle γ, and to perform a calculation of the parameter representing the yaw angle ψ using at least the parameter representing the solar angle β and the parameter representing the obturation angle γ.

In the example, the computer 44 is also adapted to obtain a parameter representing the position angle α, such as the position angle α itself, but the computer 44 does not use it in all cases, as will be explained below.

The solar angle β and the position angle α are measurements provided by already known satellite sensors (not represented), for example.

In a variant, the solar angle β and the position angle α are themselves calculated by the computer 44 from measurements.

The obturation angle γ is provided to the computer 44 or is already present in the memory (not represented) of the computer 44, for example.

The computer 44 is advantageously configured to calculate the yaw angle ψ differently, depending on whether the solar angle β belongs to ranges of values.

The computer 44 is advantageously configured so that:
if the solar angle β is greater in absolute value than a first threshold S1, then the yaw angle ψ is calculated using the solar angle β and the parameter representing the position angle α; and
if the solar angle β is less than or equal in absolute value to the first threshold S1, the yaw angle ψ is calculated independently of the position angle α.

For example, the computer 44 is configured so that:
if the solar angle β is greater in absolute value than a second threshold S2 greater than the first threshold S1, then the yaw angle ψ is calculated according to a yaw steering law such that the Sun 16 is intended to be in a plane (X,Z) defined by the axis X and the axis Z;
if the solar angle β is less than or equal in absolute value to the second threshold S2 and greater than the first threshold S1, then the yaw angle ψ is calculated according to said yaw steering law limited to a maximum value M; and
if the solar angle β is less than or equal in absolute value to the first threshold S1, the parameter representing the yaw angle ψ is equal to a constant C.

For example, the first threshold S1 is equal to the obturation angle γ divided by two.

For example, the second threshold S2 is equal to the obturation angle γ.

Advantageously, the maximum value M is equal to 180° minus the obturation angle γ, and said constant C is equal to zero.

It is thus to be noted that the first threshold S1, the second threshold S2, and the maximum value M are parameters representing the obturation angle γ.

Thus, in the example:

$$If \vert β \vert > S 2 , then : ψ = 90 ° + atan 2 [ sign ( β ) . sin ( β ) ; sign ( β ) . sin ( ∝ ) cos ( β ) ] \qquad ( 1 )$$

$$If S 1 < \vert β \vert \leq S 2 , then : ψ = Max \{ M ; 90 ° + atan 2 [ sign ( β ) . sin ( β ) ; sign ( β ) . sin ( ∝ ) cos ( β ) ] \} \qquad ( 2 )$$

$$If \vert β \vert \leq S 1 , then : ψ = C \qquad ( 3 )$$

with S1=γ; S2=γ/2; M=180°−γ; C=0°, with all angles being expressed in degrees.

The operation of the computer 44 follows from its structure and will not be described in detail. This operation illustrates a method according to the invention.

The computer 44 comprises software and a processor (not represented) adapted to execute this software to implement such a method, for example.

In a variant, the computer 44 comprises one or more programmable logic circuits, such as FGPA circuits (from the English, “Field Programmable Gate Array”) substituting the software totally or partially.

### Positioning of the Satellite

A method for positioning the satellite 10 is also deduced from the structure of the satellite 10 described above and will not be described in detail.

The parameter representing the yaw angle ψ, here the yaw angle ψ itself, is advantageously transmitted to one or more actuators (not represented) of the satellite 10 adapted to modify the effective yaw angle of the satellite 10.

For values of the solar angle β greater than γ or less than −γ, the satellite 10 follows a usual yaw steering law. The Sun 16 is in the Plane X,Z and the solar panels 36, 38 are perfectly oriented perpendicularly to the solar radiation.

For values of the solar angle β between γ/2 and γ, or between −γ and −γ/2, the yaw steering law remains the usual yaw steering law, but limited to the maximum value M.

For even lower values of the solar angle β, between −γ/2 and γ/2, the yaw control is stopped and the targeted yaw angle ψ is 0°. The axis X then points in the direction of the velocity vector of the satellite 10.

Thus, the solar panels 36, 38 undergo a maximum misalignment equal to γ/2. This creates a slight loss of electrical power provided by the solar panels 36 and 38 of 0.4% if γ=10°, for example. In addition, the face of the body 32 serving as a radiator to dissipate the heat of the satellite 10 receives slight solar radiation, of about 25 W/m² under the aforementioned conditions.

### Advantages

By means of the characteristics described above, the computer 44 is adapted to provide a parameter representing the yaw angle ψ of the satellite 10 allowing adequate positioning of the satellite 10, while the optical systems 40 and 42 dedicated to inter-satellite communication are placed on the anti-Earth face 46 in a completely counterintuitive manner. In other words, the computer 44 allows the optical systems 40 and 42 to be placed on the anti-Earth face 46 while ensuring their proper functioning.

Thus, the Earth face 34 is less cluttered, which relieves the constraint due to its clutter. In practice, the dimensions of the Earth face 34 can be reduced compared to a situation where the optical systems 40 and 42 would be on the Earth face 34.

As seen above, for low solar angles, there is a slight misalignment of the axis Y relative to a perfect yaw control, but the consequences of this misalignment are minimal compared to the benefits related to uncluttering the Earth face 34.

1. A positioning computer for a satellite adapted to provide a parameter representing a yaw angle of the satellite, the satellite being intended to move in an orbital plane, the satellite and a sub-solar point of the orbital plane being intended to define a position angle of the satellite as seen from the Earth, the satellite being intended to comprise:
a body having an Earth face defining an axis Z of the satellite intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining the yaw angle, the reference axis X0 being perpendicular to the axis Z, located in the orbital plane and oriented in the direction of an increase in the position angle, and
at least one first optical system for communicating with another satellite located in the orbital plane, the first optical system being intended to be located on an anti-Earth face of the satellite, opposite the Earth face according to the axis Z, and intended to have a field of view in azimuth around the axis Z, the field of view comprising a first direction parallel to the axis Y and extending to a second direction forming, with the first direction, an angle of 180° minus an obturation angle due to the body,
the computer being adapted to obtain a parameter representing a solar angle defined by the Sun with the orbital plane, and to perform a calculation of the parameter representing the yaw angle using at least the parameter representing the solar angle,
characterized in that the computer is configured to use a parameter representing the obturation angle in said calculation.

2. The computer according to claim 1, characterized in that it is configured to calculate the parameter representing the yaw angle differently depending on whether the parameter representing the solar angle belongs to ranges of values.

3. The computer according to claim 2, characterized in that it is configured so that:
if the parameter representing the solar angle is such that the solar angle is less than or equal in absolute value to a first threshold, the parameter representing the yaw angle is equal to a constant;
if the parameter representing the solar angle is such that the solar angle is greater in absolute value than a second threshold greater than the first threshold, then the parameter representing the yaw angle is calculated according to a yaw steering law such that the Sun is intended to be in a plane defined by the axis X and the axis Z; and
if the parameter representing the solar angle is such that the solar angle is less than or equal in absolute value to the second threshold and greater than the first threshold, then the parameter representing the yaw angle is calculated according to said yaw steering law limited to a maximum value.

4. The computer according to claim 3, characterized in that:
the first threshold is equal to the obturation angle divided by two,
the second threshold is equal to the obturation angle,
said maximum value is equal to 180° minus the obturation angle, and/or
said constant is equal to zero.

5. A satellite intended to move in an orbital plane, the satellite and a sub-solar point of the orbital plane defining a position angle of the satellite as seen from the Earth, the satellite comprising:
a body having an Earth face defining an axis Z of the satellite intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining a yaw angle of the satellite around the axis Z, the reference axis X0 being perpendicular to the axis Z, located in the orbital plane and oriented in the direction of an increase in the position angle,
at least one first optical system for communicating with another satellite located in the orbital plane, the first optical system being located on an anti-Earth face of the satellite, opposite the Earth face according to the axis Z, and having a field of view in azimuth around the axis Z, the field of view (comprising a first direction parallel to the axis Y and extending to a second direction forming, with the first direction, an angle of 180° minus an obturation angle due to the body, and
a computer according to claim 1 adapted to provide a parameter representing the yaw angle, the computer being adapted to obtain a parameter representing a solar angle defined by the Sun with the orbital plane, and to perform a calculation of the parameter representing the yaw angle using at least the parameter representing the solar angle,
characterized in that the computer is configured to use a parameter representing the obturation angle in said calculation.

6. The satellite according to claim 5, wherein the anti-Earth face defines four corners, the first optical system being fixed on one of the four corners and protruding relative to the anti-Earth face according to the axis Z towards space.

7. The satellite according to claim 6, comprising a second optical system fixed on another of the four corners and protruding relative to the anti-Earth face according to the axis Z towards space, the other of the four corners being diagonally opposite to the one of the four corners on which the first optical system is fixed.

8. A method for providing a parameter representing a yaw angle of a satellite, the satellite being intended to move in an orbital plane, the satellite and a sub-solar point of the orbital plane being intended to define a position angle of the satellite as seen from the Earth, the satellite being intended to comprise:
a body having an Earth face defining an axis Z of the satellite intended to point towards the Earth,
at least one solar panel mounted rotatably relative to the body around an axis Y of the satellite perpendicular to the axis Z, the satellite defining an axis X perpendicular to the axis Y and the axis Z, the axis X and a reference axis X0 defining the yaw angle, the reference axis X0 being perpendicular to the axis Z, located in the orbital plane and oriented in the direction of an increase in the position angle, and
at least one first optical system for communicating with another satellite located in the orbital plane, the first optical system being intended to be located on an anti-Earth face of the satellite, opposite the Earth face according to the axis Z, and intended to have a field of view in azimuth around the axis Z, the field of view comprising a first direction parallel to the axis Y and extending to a second direction forming, with the first direction, an angle of 180° minus an obturation angle due to the body,
the method comprising:
a computer according to claim 1 obtaining a parameter representing a solar angle defined by the Sun with the orbital plane, and
the computer calculating a parameter representing the yaw angle using at least the parameter representing the solar angle,
characterized in that the method comprises the computer using a parameter representing the obturation angle in said calculation.

9. A method for positioning a satellite according to claim 5, the satellite moving in an orbital plane, the satellite and a sub-solar point of the orbital plane defining a position angle of the satellite as seen from the Earth, the method comprising:
the computer obtaining a parameter representing the solar angle, and
the computer calculating a parameter representing the yaw angle using at least the parameter representing the solar angle,
characterized in that the method comprises the computer using a parameter representing the obturation angle in said calculation.
